(19) United States
(12) Patent Application Publication
(10) Pub. No.: US 2006/0182401 A1
(43) Pub. Date: Aug. 17, 2006

(54) Liquid crystal materials and electrooptic devices with a liquid crystal-containing cladding

(75) Inventors: Steven M. Risser, Reynoldsburg, OH (US); Vincent D. McGinnis, Sunbury, OH (US); Kevin B. Spahr, Worthington, OH (US); Richard J. Higgins, Hilliard, OH (US); Richard W. Ridgway, Westerville, OH (US); Zhihua Huang, Pittsburgh, PA (US); Edward Jiang, Columbus, OH (US)

Correspondence Address: J. K. Mueller, Jr.;Mueller and Smith, LPA, 7700 Rivers Edge Drive, Columbus, OH, 43235, US

(73) Assignee: Optimer Photonics, Inc.

(21) Appl. No.: 11/403,657

(22) Filed: Apr. 13, 2006

Related U.S. Application Data
(63) Continuation of application No. PCT/US04/34017, filed on Oct. 14, 2004.

(51) Int. Cl. G02B 6/10

(52) U.S. Cl. 385/129; 385/141; 385/144

(57) ABSTRACT

Broadly, then, one aspect of the present invention is a functional optical material composed of a liquid crystal (LC) evidencing a pair of refractive indices (RI's) and a polymer in which the LC is dispersed. The refractive index (RI) of said polymer may be outside of the L C RI's by at least about 0.03. Another aspect of the present invention is a functional optical material composed of a liquid crystal (LC) and a polymer in which the LC is dispersed, wherein said LC is less than about 5% miscible in said polymer. A further aspect of the present invention is a functional optical material composed of a liquid crystal (LC) and a polymer in which the LC is dispersed, wherein the cladding contains not more than about 20 wt-% LC. In all of these embodiments, the functional optical material can be clad to an optical waveguide and can optionally contain a chromophore. In yet another aspect of the present invention, a functional optical waveguide is composed of a polymer having a refractive index, RI_{P} and an optical waveguide clad having a refractive index, RI_{WG}, wherein RI_{P} is at least about 0.3% lower than RI_{WG} under operating conditions of said clad optical waveguide.

### CROSS-REFERENCE TO RELATED APPLICATIONS

Benefit of priority of PCT/US2004/034017 filed 14 Oct. 2004 is claimed.

### STATEMENT REGARDING FEDERALLY SPONSORED RESEARCH

Not applicable.

### BACKGROUND OF THE INVENTION

The present invention generally relates to electrooptic materials and devices and more particularly to a functional polymer-dispersed liquid crystal (PDLC) electrooptic material which may be used as a functional cladding for electrooptic devices.

There is an extensive collection of prior art on use of PDLC's in devices. There are commercial tailorable windows based on the scattering properties of PDLC films. There have been reports of fiber-based optical attenuators (See, e.g., K. Takizawa, et aL, “Polarization-Independent Optical Fiber Modulator by Use of Polymer-Dispersed Liquid Crystals,” Applied Optics, Vol. 37, 3181 (1998)), where the PDLC film is inserted between two fibers and transmission through the film is controlled by an electric field.

There have been reported waveguide-based devices, where PDLC's have been used as either the waveguide or the cladding (See, e.g., B. J. Eggleton, et al., “Waveguide Incorporating Tunable Scattering Material,” U.S. Pat. No. 6,529,676 (2003)). In this device, the PDLC acts as an optical attenuator, reducing the intensity of the propagating light. In addition, there have been reports where the phase change of light propagating through a simple PDLC film due to the electrooptic effect have been reported (See, e.g., L. Vicari, “Electro-Optic Phase Modulation by Polymer Dispersed Liquid Crystals,” Journal of Applied Physics, Vol. 81, 6612 (1997): D. E. Lucchetta, et al., “Phase-Only Modulation by Nanosized Polymer-Dispersed Liquid Crystals”, Journal of Applied Physics, Vol. 91, 6060 (2002): O. Levy, “Electro-Optical Phase Shift in Polymer Dispersed Liquid Crystals,” European Physics Journal E, Vol. 3, 11 (2000): F. Basile, et al., “Optical Phase Shift of Polymer-Dispersed Liquid Crystals,” Physical Review E, Vol. 48, 432 (1993) ).

There is no prior art, however, where PDLC's have been used as the cladding of a silica waveguide device to induce phase change in the light propagating in the waveguide. In all other cases, the PDLC material was used as a controllable scattering medium to allow device control. This is also the first demonstration of the ability to electrically alter the phase of light passing through a PDLC medium without substantially altering the transmission loss of the light. In addition, there is no prior art where a chromophore-containing PDLC has been used as the cladding of a waveguide to alter the phase behavior of the light propagating in the waveguide.

### BRIEF SUMMARY OF THE INVENTION

The PDLC materials of this invention are novel in several aspects. The materials contain a much lower concentration of liquid crystal than is commonly used to cause phase separation into polymer matrix with liquid crystal droplets. This is due to enhanced incompatibility between the liquid crystal and the proprietary low refractive index host polymers. However, there are additional constraints imposed on the materials, as evidenced by the limited function of some liquid crystal/polymer combinations. The use of a low liquid crystal concentration leads to formation of much smaller liquid crystal droplets, leading to greatly reduced light scattering, evidenced by the low transmission loss of devices fabricated with this material as the cladding. Also, the polymer is NOT matched to either refractive index of the liquid crystal, as is the case for scattering-based PDLC materials. This leads to small variation in the transmitted intensity of light through the material due to application of the control field. The optional inclusion of the chromophore in the system is also unique. The chromophore phase separates in conjunction with the liquid crystal, and acts to enhance the optical anisotropy of the droplets. The choice of chromophore depends on both the polymer and liquid crystal, as the chromophore must preferentially remain in the LC phase, and must align parallel with the liquid crystal director. We demonstrate the electrooptic response of these different materials, under a variety of conditions such as bias voltage or temperature, using an experimental method taken from the literature.

Mach-Zehnder devices are constructed using these novel liquid crystalline/polymer materials as the functional cladding over silica waveguides. These devices differ from standard Mach-Zehnder devices in that the cladding over the waveguide is the functional material. Application of a DC or low frequency AC voltage to the cladding of one or both arms of the Mach-Zehnder, when the temperature is within the range where the droplets exhibit liquid crystalline behavior, leads to orientation of the molecules within the liquid crystal droplets, such that the effective refractive index of the droplet is different along the direction of the electric field. Light propagating through the waveguide interacts with this altered refractive index, giving rise to a phase change in light propagating down one arm of the Mach-Zehnder, allowing for control of the output of the device. This is in contrast to prior art PDLC devices, where the PDLC was the waveguiding medium, and attenuation of light in the waveguide was the primary mechanism for controlling light propagation. The fact that the device is operating by changing phase instead of attenuation is given by the multiple Mach-Zehnder cycles that have been demonstrated. Operation of the device at temperatures above where liquid crystalline behavior is exhibited by the droplets leads to greatly reduced device performance.

Broadly, then, one aspect of the present invention is a functional optical material composed of a liquid crystal (LC) evidencing a pair of refractive indices (RI's) and a polymer in which the LC is dispersed. The refractive index (RI) of said polymer may be outside of the LC RI's by at least about 0.03. Another aspect of the present invention is a functional optical material composed of a liquid crystal (LC) and a polymer in which the LC is dispersed, wherein said LC is less than about 5% miscible in said polymer. A further aspect of the present invention is a functional optical material composed of a liquid crystal (LC) and a polymer in which the LC is dispersed, wherein the functional optical material contains not more than about 20 wt-% LC. In all of these embodiments, the functional optical material can be clad to an optical waveguide and can optionally contain a chromophore. In yet another aspect of the present invention, a functional optical waveguide is composed of an optical functional material from above having a refractive index, RI_{P} and an optical waveguide clad having a refractive index, RI_{WG}, wherein RI_{P} is at least about 0.3% lower than RI_{WG} under operating conditions of said clad optical waveguide.

An additional aspect is functional optical material formed from a liquid crystal (LC) and a polymer in which the LC is dispersed, wherein the functional optical material has refractive index of less than 1.46. A further aspect is functional optical material formed from a liquid crystal (LC) and a polymer in which the LC is dispersed, wherein the polymer formed from the reaction product of one or more of (1) at least two pre-polymers having a weight average molecular weight of at least about 1,000; or (2) a polymer having self cross-linking functional groups and reactive agent reactive with said self cross-linking functional groups. Yet a further aspect is an optical device one or more of fabricated using or clad with a functional optical material of a liquid crystal (LC) and a polymer in which the LC is dispersed, wherein the refractive index (RI) of the polymer is outside of the LC RI's by at least about 0.03, and wherein the optical device is capable of changing the phase of an optical signal without appreciable change in optical scattering of said optical signal. Appreciable change in optical scattering is defined as an optical scattering of less than about 2 db/cm with optical scatterings of less than about 0.5 db/cm demonstrated in the examples set forth herein. Yet another aspect is a photonic band gap composite media formed from a host matrix and an array dispersed in the host matrix, wherein one or more of said host matrix or said array is formed from a liquid crystal (LC) having a refractive index (RI) and a polymer in which the LC is dispersed, wherein the refractive index (RI) of the polymer is outside of the LC RI by at least about 0.03.

Another aspect is a method for controlling the electrooptical output of functional optical material formed from a liquid crystal (LC) and a polymer in which the LC is dispersed, wherein the LC is less than about 5% miscible in the polymer. Such process includes adding a plasticizer to the functional optical material, the proportion of plasticizer in the functional optical material controlling the electrical output thereof. Yet another aspect is a functional optical material formed from a liquid crystal (LC) and a polymer in which the LC is dispersed, wherein one or more of said LC or the polymer containing fluorine groups and the polymer contains at least 5 molar-% polar groups. These and other aspects of the present invention will be readily apparent to those skilled in the art based on the disclosure set forth herein.

### BRIEF DESCRIPTION OF THE DRAWINGS

For a fuller understanding of the nature and advantages of the present invention, reference should be had to the following detailed description taken in connection with the accompanying drawings, in which:

FIG. 1 depicts sample LC droplet directors for a radial, an axial, and a bipolar droplet, where the straight lines indicate the preferred orientation of the molecules at that point within the droplet;

FIG. 2 is a schematic showing orientation of bipolar droplets in the absence of, or under the influence of a field, wherein the black lines on the droplets represent the director orientation;

FIG. 3 is a schematic of the Mach-Zehnder device of the present invention;

FIG. 4 is a cross-sectional view of the device of FIG. 3 taken through the active region 4-4;

FIG. 5 is a schematic of the sample used in the EO cell from data reported herein was recorded, wherein the light is polarized 45° out of the plane of the paper;

FIG. 6 depicts the general requirements for LC/polymer compatibilization, as reported in Example C;

FIG. 7 depicts EO response as a function of temperature, as reported in Example J;

FIG. 8 depicts EO response as a function of time for the test cell reported in Example M;

FIG. 9 depicts refractive index as a function of temperature, as reported in Example O;

FIG. 10 depicts the response of a Mach-Zehnder device to sinusoidal voltage, as reported in Example P;

FIG. 11 depicts the voltage dependent response of the Mach-Zehnder device to a sinusoidal voltage, as reported in Example P;

FIG. 12 depicts performance of a Sea Bass 3 device at 40° C. under the influence of an alternative square-wave voltage, as reported in Example Q;

FIG. 13 depicts performance of a Sea Bass 3 device at 50° C. under the influence of an alternative square-wave voltage, as reported in Example Q; and

FIG. 14 depicts performance of a Fluorine 4 device at 45° C. under the influence of a sinusoidal voltage, as reported in Example R.

### DETAILED DESCRIPTION OF THE INVENTION

### (I)—Materials

(1)—Liquid Crystals

Polymer-dispersed liquid crystals (PDLC's) are well-known in the art. (See, e.g., K. Amundson, et al., “Morphology and Electro-Optic Properties of Polymer-dispersed Liquid-Crystal Films,” Physical Review E, Vol. 55, 1646 (1997)). A liquid-crystal mesophase of interest in the invention is the nematic phase, in which rod-like (e.g., 30 Å-long), organic liquid-crystal molecules tend to align along a common direction (so-called director), while possessing no overall translational order. The nematic phase is birefringent, commonly with an extraordinary refractive index (nₑ) along the director, and ordinary refractive index (nₒ) along the orthogonal short axes. Typical refractive index values are nₑ about.1.7 and nₒ about.1.5, although materials with lower birefringence and lower nₒ are commercially available. In particular, the refractive indices of 5OCB at 589 nm are reported as nₑ=1.7058, nₒ=1.5260, while the refractive indices at 1550 nm will be lower by approximately 0.02.

Refractive indices of the overall system can be defined as high, intermediate, or low as follows:

High RI n>1.50

Intermediate RI 1.46>n>1.50

Low RI n<1.46

The following diagram phrases these results in terms of refractive index.

| | |
|---|---|
| | Poor overall performance |
| Good overall performance | at low LC concentration |
| (high EO, low optical loss, | (low EO, high optical loss |
| low LC concentration) | at high LC concentration) |
| low n | high n |

| | | | | | | |
|---|---|---|---|---|---|---|
| fluorocarbon | > | fluorocarbon/hydrocarbon | > | fluorocarbon/hydrocarbon | > | hydrocarbon |
| polymers with | | copolymers with polar | | copolymers or hydrocarbon | | polymers |
| polar functionality | | functionality | | polymers with polar | | |
| | | | | functionality | | |

(2)—Polymer-Dispersed Liquid Crystals (PDLC)

Polymer-dispersed liquid crystals (PDLC) consist of an unordered array of small liquid crystal droplets or regions contained within a host polymer matrix. The dispersion of liquid crystal inside a polymer can be formed in multiple ways. The most common approach is by mixing the liquid-crystal material with a photocurable monomer at an appropriate volume ratio, and then curing the monomer with UV radiation (photopolymerization-induced phase separation or PIPS). The cross-linking of the polymer leads to phase separation due to the decreasing miscibility of the liquid crystal in the polymer, trapping the liquid crystal in droplets, the sizes of which are capable of being adjusted by suitable choice of volume fractions and curing intensities. An alternate PIPS approach involves mixing a reactive monomer and the liquid crystal in the appropriate ratios, and thermally initiating the polymerization. As the monomer grows into the polymer, the liquid crystal becomes immiscible in the polymer, leading to phase separation. Again, the choice of volume fractions and polymerization conditions controls the size of the liquid crystal droplets formed in the polymer matrix.

A second fabrication approach is thermally induced phase separation, or TIPS, which can be used when the host polymer has a melting temperature below its decomposition temperature. In this method, a homogeneous mixture of liquid crystal and a melted polymer is formed at a temperature above Tg of the polymer. The solution is cooled at a specific rate to induce phase separation due to the decreasing of the miscibility of the liquid crystal in the hardening polymer. Liquid crystal droplets begin to form as the polymer hardens. The droplets continue to grow until the glass transition temperature of the polymer is crossed. Droplet size is most affected by the cooling rate of the polymer melt/liquid crystal solution. Fast cooling rates tend to produce small droplets because there is not sufficient time for large particles to form. Therefore, droplet size and cooling rate are related inversely.

A third fabrication approach involves mixing immiscible polymer and liquid crystal in a mutual solvent. As the solvent is evaporated off, the liquid crystal phase separates from the polymer, leading to formation of the liquid crystal droplets (solvation-induced phase separation or SIPS). Droplets start growing as the polymer and liquid crystal come out of solution and stop when all of the solvent has been removed. Again, the rate at which solvent is removed, and the degree of immiscibility of the LC in the polymer will control the droplet morphology.

(3)—Synthesis of Fluorinated Polymers for Use in this Invention

Unless noted otherwise, the polymers used in this invention were prepared were polymerized in dioxane in accord with typical free radical polymerization processes (Soremon and Campbell, Preparing Methods of Polymer Chemistry, 1961, Interscience Publishers, New York, N.Y., pp. 149-215). Unless noted otherwise, the monomers were purchased from a variety of commercial vendors. The composition of the polymers used throughout this invention are detailed in the following.

| Polymer | | Polymer RI |
|---|---|---|
| Name | Polymer Composition | (1550 nm) |
| CP034 | 100% TFEMA | 1.4113 |
| CP033 | 100% TFPMA | 1.3942 |
| Run46 | 21% TFEMA, 52% TFPMA, 27% HEMA | 1.4336 |
| Spike 3 | 80.6% TFPMA, 14.4% TFEMA, 5% HEMA | 1.4189 |
| pMMA | 100% MMA (purchased from | 1.48 |
| | Polysciences) | |
| CP056 | 65% TFEMA, 30% MMA, 5% HEMA | 1.4306 |
| Run18 | 66% TFEMA, 34% MMA | 1.4363 |
| CP052 | 25% HFIPA, 75% MMA | 1.4347 |
| CP051 | 50% TFEMA, 50% MMA | 1.4384 |
| CP044 | 20% TFEMA, 65% TFPMA, 15% HEMA | 1.4263 |
| VP01 | 80% MMA, 20% HEMA | 1.49 |
| KP001 | 10% NCO, 55% HFBMA, 35% TFEMA | 1.4129 |

*Ingredients
TFEMA = trifluoroethyl methacrylate monomer
TFPMA = tetrafluoropropyl methacrylate monomer
MMA = methyl methacrylate monomer
HEMA = hydroxyethyl methacrylate monomer
HFIPA = hexafluoroisopropyl acrylate monomer
HFBMA = hexafluorobutyl methacrylate monomer
NCO = isocyanate functional methacrylate monomer
RI = refractive index (589 nm)
All % are molar composition

(4)—Chromophore-Containing Polymer-Dispersed Liquid Crystals (C-PDLC)

It is well-known in the literature that mixing liquid crystals with other molecules can lead to orientation of the other molecules in the liquid crystal phase, particularly if the molecule is similar in structure to the liquid crystal. The present invention adds several proprietary chromophores to the PDLC systems, and is based, in part, on the discovery that the response of the combined system is strongly dependent on the selected chromophore, with highly enhance EO response possible.

(5)—PDLC Droplet Size

Typical liquid crystal droplet sizes in PDLC materials range from nanometers to several microns. The separation between the droplets also depends on volume fraction and curing parameters, and generally ranges from separations similar to droplet diameter to cases where droplets are separated by only very narrow polymer walls that have a thickness that is much less than droplet size. The size of the droplets for PIPS and TIPS is controlled by the polymerization conditions, as well as the volume fraction of liquid crystal in the polymer. However, the droplets may contain only a small fraction of the included LC, with the rest remaining dispersed in the polymer, due to the miscibility of the LC in low molecular weight polymer. In many systems, there is a threshold volume fraction below, which no phase separation occurs, with this threshold ranging from about 10 wt-% to up to 50 wt-% LC.

Although the formation of liquid crystal droplets many microns in diameter has been known since the inception of PDLC technology, recent work using the PIPS method has shown the ability to form droplets much smaller. In particular, there have been reports of PDLC films with droplets ranging down to 35 nm in size (See, e.g., R. A. Vaia, et al., “Two-phase Nanoscale Morphology of Polymer/LC Composites,” Polymer, Vol. 42, 1055 (2001); S. Matsumoto, et al., “Fine Droplets of Liquid Crystals in a Transparent Polymer and Their Response to an Electric Field,” Applied Physics Letters, Vol. 69, 1044 (1996)). Here again, much of the LC remains outside of the droplets.

The use of SIPS leads to a much less uniform droplet size distribution. However, there is evidence suggesting that a larger fraction of the liquid crystal is contained within the droplets. Evidence for this comes from experiments showing EO response of the system at lower LC fractions than observed with PIPS or TIPS systems.

(6)—Droplet Director Configuration

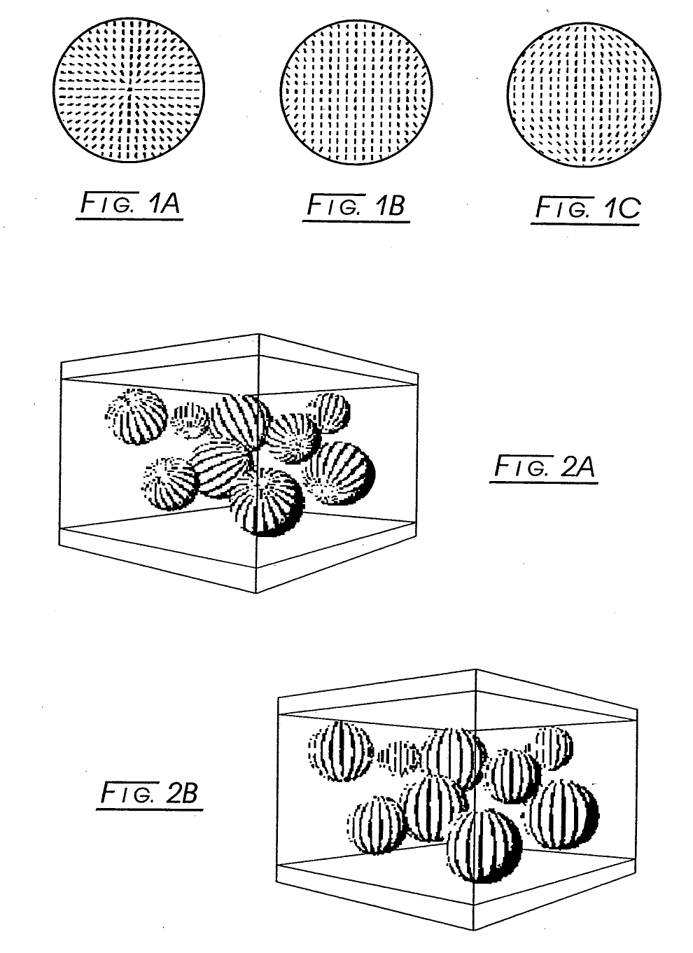

When the LC forms a droplet, the droplet adopts a specific director configuration. Many different configurations have been observed in droplets and the actual configuration formed depends on factors such as droplet size and shape, surface anchoring, and applied fields. The radial configuration occurs when the liquid crystal molecules are anchored with their long axes perpendicular to the droplet walls. This arrangement is shown in FIG. 1. Note the point defect in the center of the droplet. The axial configuration of the liquid crystal droplets also occurs when the molecules are oriented perpendicular to the droplet wall, but only when there is weak surface anchoring, or in the presence of an electric field above the threshold magnitude. This configuration creates a line defect that runs around the equator of the spherical droplet, as also seen in FIG. 1. When an electric field is applied to a radial droplet, the molecules adopt the axial configuration. The radial configuration is returned when the field is removed. The bipolar configuration is obtained by tangential anchoring of the liquid crystal molecules. This creates two point defects at the poles of the droplet and is shown further in FIG. 1. When an electric field is applied to a bipolar droplet, the axis connection of the two polar defects rotates to lie along the direction of the applied field.

(7)—Scattering and PDLC Function

Since the nematic liquid crystal phase is uniaxial, the liquid crystal droplets formed inside the polymer matrix also can be uniaxial, except for the radial configuration. For the axial and bipolar droplets shown in FIG. 1, the droplet will have an extraordinary index along the vertical direction, while the ordinary index is along the horizontal direction. The radial droplet in FIG. 1 is homogeneous, with a droplet refractive index between that of the ordinary and extraordinary indices of the liquid crystal.

PDLC's operate on the principle of electrically controlled light scattering, with the details of the mechanism dependent on the specific droplet director configuration. For the radial configuration, the droplets in the zero-field state are homogeneous, with refractive index \overline{n}˜({nₑ+2nₒ)/3}); while when the field is applied, the droplet transitions to the axial configuration, with droplet indices approximately equal to nₑ and nₒ. Assuming the light propagates along the direction of the applied field, if the refractive index of the host polymer also is nₒ, the droplets in the zero-field case scatter due to the refractive index mismatch between nₒ and \overline{n}; while with the field applied, any light propagating along the direction of the applied field sees an approximately homogeneous medium of index, nₒ, and so is transmitted. The amount of light scattered by each droplet depends on the size of the droplet relative to the wavelength of the light and the refractive index mismatch between the droplet and the host polymer.

For PDLC materials where the droplet is in the bipolar configuration, the scattering mechanism is slightly different. The bipolar droplets are intrinsically uniaxial, with droplet refractive indices approximately equal to nₑ and nₒ, but the optical axis of each droplet is randomly oriented, as illustrated in FIG. 2. Application of an external field causes reorientation of the optic axis to lie along the direction of the applied field. Again, assuming the light propagates along the direction of the applied field, if the polymer index is approximately nₒ, when there is no field the light is scattered due to the refractive index mismatch between the polymer and most of the droplets; while when the field is applied, light propagating along the direction of the field will see an approximately homogeneous medium, and will not be scattered. As before, the amount of scattering by each droplet depends on the droplet director, the refractive index mismatch between the droplet and the polymer, and the size of the droplet relative to the wavelength of the light.

### (II)—Optics and Devices

(1)—Device Configuration

A Mach-Zehnder interferometric device works by splitting light into two equal beams, altering the relative phase of the two beams, and then re-combining them. The relative phase difference between the beams allow for selection of the output port for the light. An EO polymeric device works by using the electrooptic effect in the polymeric material (LC/polymer blend) to create the phase change. In an electrooptic polymeric material, as an electric field is applied, the refractive indices of the polymeric material change.

(2)—Functional Cladding of Waveguides

In a Mach-Zehnder device configuration, the change in the effective refractive index of one arm can be accomplished by altering the refractive index of (a) the waveguide material, (b) the cladding, or (c) both the waveguide and cladding. The second case is referred to as a functional cladding, while the third case has both functional cladding and waveguide material. Use of a functional cladding has advantages and disadvantages over use of a functional waveguide material. Use of a functional cladding allows for silica to be the primary waveguide, with its ease of fabrication and low optical loss. As a disadvantage, use of a functional cladding leads to a smaller phase change in the guided mode per unit change in the refractive index of the cladding. Through proper device design, however, this penalty can be reduced to where 60% or more of the cladding phase change is obtained in the phase of the guided mode.

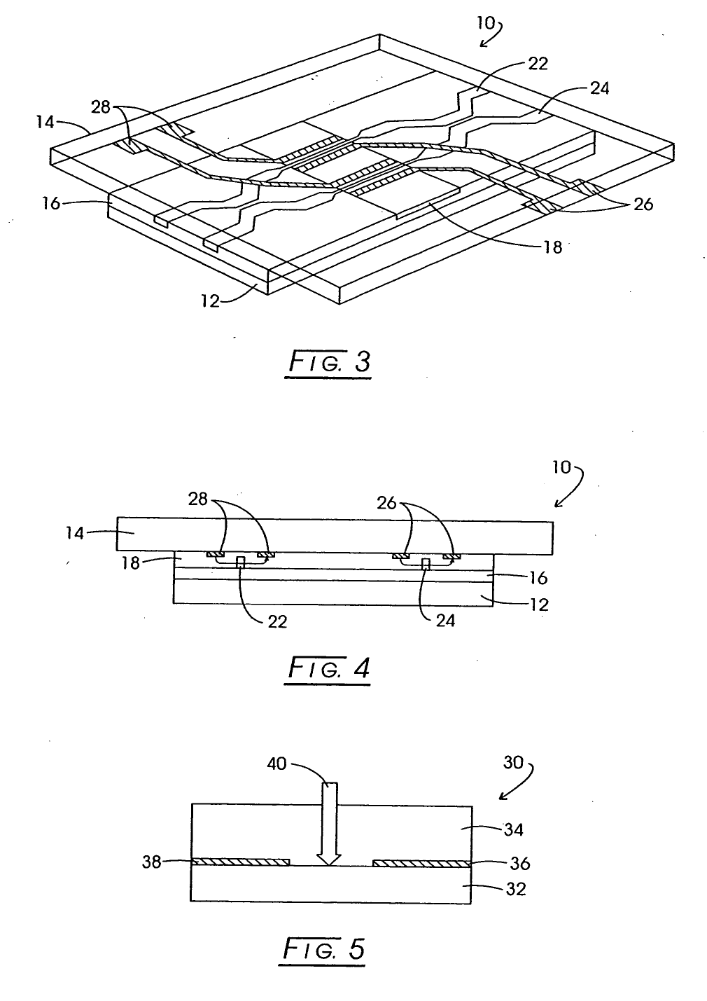

FIG. 3 shows one possible Mach-Zehnder configuration used for this device, where directional couplers are used to separate the light along the two arms, and then recombine it. Mach-Zehnder device, 10, is formed from a base silica substrate, 12, that carries two additional silica sheets, 14 and 16. Sandwiched between silica sheets 14 and 16 is a wave guide, 18, that carries an EO polymer, 20, split waveguide core or legs, 22 and 24, and electrode pairs, 26 and 28. Alternately, some measurements were taken using a Y-splitting Mach-Zehnder, where a Y-splitter is used to separate the light and a Y-combiner is used to bring the light back together. FIG. 4 shows a cross-section of either device in the active region. The material used in the active region consists of either the PDLC or C-PDLC.

(3)—Mach-Zehnder Device Fabrication

The Mach-Zehnder devices were prepared in the following fashion. After cleaning of the waveguide chips, the specified quantities of polymer, liquid crystal, and optionally chromophore, were dissolved in sufficient dioxane (or other suitable solvent) to achieve a solution containing approximately 1-10 percent solids. This solution then was passed through a 0.2 μm filter, after which solvent was allowed to evaporate until the solution contained approximately 12% solids. If the material was to be applied to an EO test cell, it then was applied with a dropper to the slide containing the electrodes, until a film of approximately 10-15 μm was formed. If the material was to be applied to a Mach-Zehnder device, the refractive index of the material was checked using the prism coupling method. If the refractive index of the material was within the specified range, a small quantity of the solution then was applied to the waveguide chip using a dropper, until a film approximately 30 μm thick, or more, was formed over the active region of the waveguide chip. The coated chip then was dried in a 70° C. oven for 12-72 hours to remove the solvent, after which it was removed for assembly. The device was assembled by heating the coated chip to approximately 120° C., then placing a silica slide containing the electrodes on top of the material. The temperature then was increased and pressure applied to the electrode slide until the thickness of the polymer layer decreased to approximately 10 μm. After cooling, the device was removed from the assembly jig and wires attached to the electrodes.

(4)—EO Test Cell

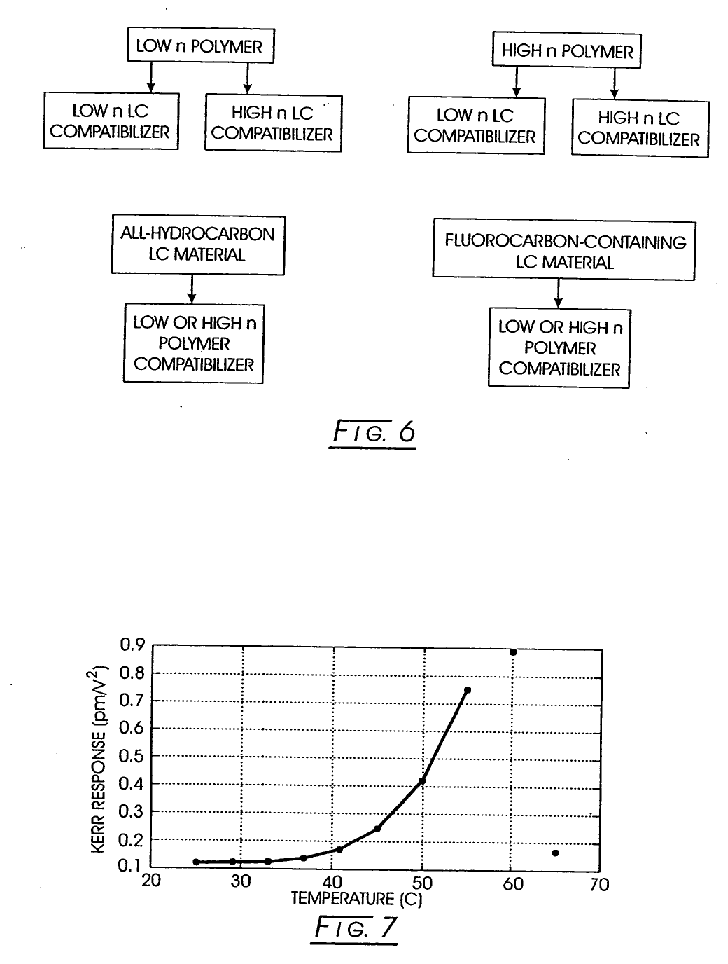

The need to rapidly and cheaply investigate the EO response has led to adoption of an alternate experimental method, similar to that used to measure the electrooptic effect in poled polymer systems. FIG. 5 shows a schematic of the test cell used to determine the magnitude of the EO response for various polymer/LC combinations reported herein, and also for different film PDLC formation methods. In FIG. 5, an EO cell, 30, is seen to be composed of a silica substrate, 32, fitted with an electrode pair, 36 and 38, with a 20 μm gap between the electrodes. The EO material, 34, then was applied to cover the two electrodes and the gap between them and baked to remove the solvent.

To measure the EO response of LC-containing materials, the laser beam was passed through the gap between the electrodes, in the direction of arrow 40 perpendicular to polymer 34. The beam polarized 45° to the direction of the gap. When an AC voltage was applied between the electrodes, the refractive index for light polarized in the plane of the paper will be altered, while that for light polarized normal to the paper will be unaffected, leading to a change in the relative phase of the two polarizations of the light as it traverses the sample. The variation in the transmitted power due to this changing phase difference at the same frequency as the AC voltage (measured using a lock-in amplifier) can then be directly related to the EO response of the polymer film. In all the reported measurements, a DC bias voltage was applied in addition to the sinusoidal, 200 V peak-to-peak, 1 kHz, AC voltage.

### (III)—Novel Liquid Crystals and Liquid Crystal/Polymer Blends

Prior LC systems involved the use of all hydrocarbon polymers and hydrocarbon LC's or fluorocarbon-containing LC materials. Such prior systems suffer from poor percentage light transmission and from low EO values at low LC loadings. The inventive LC systems are made from specially designed fluorine-containing copolymers for hydrocarbon or fluorocarbon LC materials, and specially designed fluorine and hydrocarbon containing LC materials. Such novel LC material systems result in good percentage light transmission, low percentage loadings, and high EO values.

Examples of possible polymer variables include: 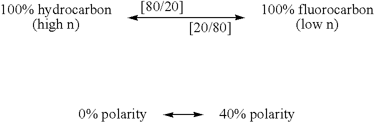
where, polarity=—OH, —CN, —COOH, —COO-alkyl, —NCO, and other polar functional groups.

The following table looks at all hydrocarbon LC materials and address what type of polymer systems are required in order to obtain acceptable EO performance.

TABLE 1
All Hydrocarbon LC Molecules*

| System | Performance |
|---|---|
| I. 100% Hydrocarbon polymer | Need high LC concentrations |
| (polymers or copolymers that contain | (greater than 20%) to get EO |
| no fluorocarbon structures. Examples | values, but refractive index is |
| include PMMA, PC, PS, polyesters, | high and optical loss is large |
| polyimides) | (from 10's to 1000's of dB/cm). |
| II. Polymers or copolymers that do | Can have low LC concentrations |
| contain high levels of fluorocarbon | (less than 20%) and also get |
| structures (TFEMA, TFEA, TFPMA, | large EO values and acceptable |
| TFPA, fluorinated polyesters, | optical clarity with low refractive |
| polyimides, fluorostyrene polymers) | index. |
| III. Combination of polymers that | Can have low LC concentrations |
| contain fluorocarbon and | (less than 20%) and also get |
| hydrocarbon structures | large EO values and acceptable |
| (copolymers and | optical clarity with low refractive |
| TFEMA/MMA) | index. |
| IV. Copolymers of fluorine- | Very clear films, high EO values |
| containing monomers (TFEMA, | and low refractive index values at |
| TFPMA) and polar monomers | low LC concentrations |
| (HEMA, NVP, THFMA) | |
| V. Copolymers of fluorine containing | Very clear films, high EO values |
| monomers (TFEMA, TFPMA) | and low refractive index values at |
| hydrocarbon monomers (MMA, | low LC concentrations |
| EMA, Styrene) and polar | |
| monomers (HEMA, NVP, | |
| THFMA) | |

*TFEMA = trifluoroethyl methacrylate monomer TFEA = trifluoroethyl acrylate monomer TFPMA = tetrafluoropropyl methacrylate monomer TFPA = tetrafluoropropyl acrylate monomer MMA = methyl methacrylate monomer HEMA = hydroxyethyl methacrylate monomer

This data establishes the advantages using polymers having fluorine content and the additional advantages of using polymers that having fluorine content and polar molecule content.

Examples of possible liquid crystal variables include:
100% hydrocarbon [symbol] 50% fluorocarbon

Examples of possible system variables are displayed in Table 2, below:

TABLE 2
Possible System Variables and Their Effect on System Response

| SYSTEM | RESPONSE |
|---|---|
| 100% hydrocarbon polymer | Poor (EO, % light transmission, |
| 100% hydrocarbon LC | refractive index control) |
| 100% hydrocarbon polymer | Poor (EO, % light transmission, |
| 50% fluorocarbon LC | refractive index control) |
| 100% hydrocarbon polymer | Poor (EO, % light transmission, |
| 100% hydrocarbon LC or 50% | refractive index control) |
| fluorocarbon LC | |
| Combination of 80/20 or 20/80 | Fair to Good (EO % light |
| hydrocarbon/fluorocarbon polymer | transmission, low concentration |
| with or without a polar functionality | of LC materials, refractive index |
| 100% hydrocarbon LC or 50% | control) |
| fluorocarbon LC | |

Based on the data displayed in Table 1, it will be apparent that a system with a combination of hydrocarbon/fluorocarbon polymer with or without a polar functionality, or a 100% hydrocarbon LC or 50% fluorocarbon LC, yields good EO properties of % light transmission, low concentration of LC materials, and refractive index control. This same data also define the inventive LC system over the prior art.
(A)—Flourinated Liquid Crystal Materials

The known general reaction scheme for preparing fluorinated liquid crystalline materials is as follows:

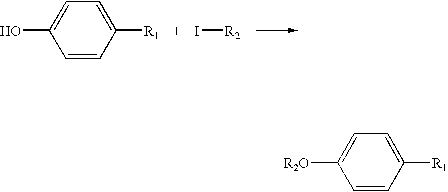

Examples of materials envisioned as part of this invention and made from different R₁ and R₂ building blocks are shown below:

TABLE 3
Examples of chemical groups that can be used with
the LC materials of this invention

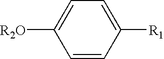

| R₁ | R₂ |
|---|---|
| 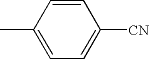 | CF₃(CF₂)₄CF₂— |
| 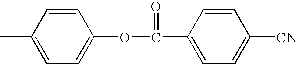 | CF₃(CF₂)₆CF₂— |
| 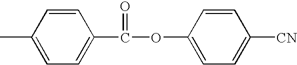 | CF₃CF₂— |
| 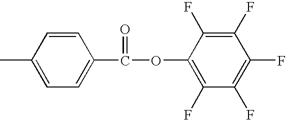 | CF₃(CF₂)₄CH₂— |
| | CF₃(CF₂)₇CH₂CH₂— |
| | CF₃(CF₂)₃CH₂— |
| | CF₃CF₂CH₂CH₂— |
| | CF₃CH₂CH₂CH₂— |

The liquid crystal materials of this invention have the following range of compositions:

TABLE 4
Ratio of Components of LC

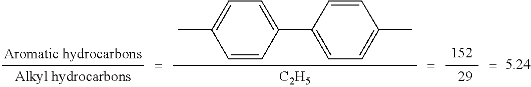

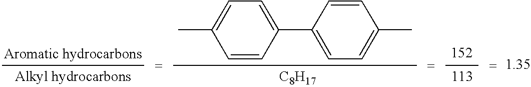

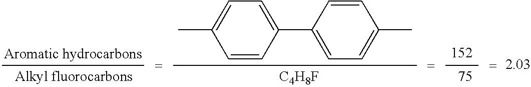

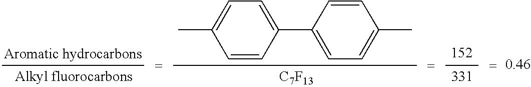

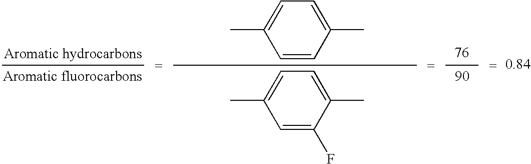

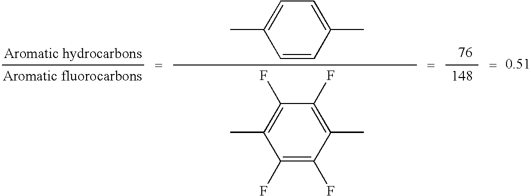

Specific examples of fluorinated liquid crystal materials can be made in the following manner: 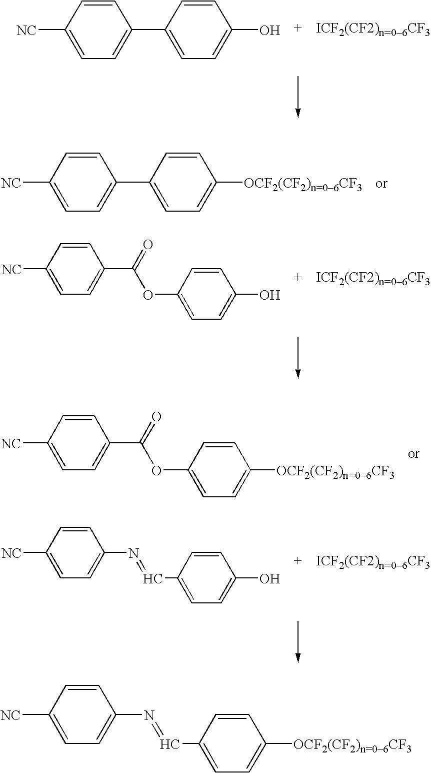
The methods for synthesis of the types of fluorinated liquid crystalline materials are contained in the following references:

(1) Liquid Crystals, vol. 24, no 4, pp 539-542 (1998).

(2) Liquid Crystals, vol. 21, no 1, pp 95-102 (1996).

(3) Journal of Fluorine Chemistry, vol. 109, pp 363-374 (2001).

(4) Journal of Fluorine Chemistry, vol. 100, pp 85-96 (1999).

(5) Chemical Communications, pp 441-442 (1989).

(6) Liquid Crystals, vol. 21, no 1, pp 121-123 (1996).

The fluorinated liquid crystal also may be attached to the backbone of a fluoropolymers to realize the following advantages: enhanced optical quality, long-term durability, and control of the phase dispersion, which enhances the EO properties of the total system. The fluorinated liquid crystalline structures also enhance phase dispersion, while maintaining optical clarity, durability, and EO properties.

### EXAMPLE A

A mixture of 0.01 mole (1.95 g) of 4′-hydroxy-4-biphenylcarbonitrile and 0.01 mole (4.45 g) of 1-iodoperfluorohexane were reacted in the presence of potassium hydroxide and ethanol under the same conditions as described in references 1 and 6 from above. The resulting product was: 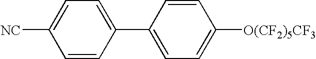
This product was blended (10% by weight) with a fluoropolymer mixture (30 wt-% trifluoroethyl methacrylate, 60 wt-% tetrafluoropropyl methacrylate, 8 wt-% hydroxyethyl methacrylate, and 2 wt-% of an alkylsilane ester of methacrylic acid).

### EXAMPLE B

Hexafluoroglutaryl chloride was converted to 1-iodohexafluoropropyl chloride via high temperature (350° C.) reaction with KI (reference 5 from above). 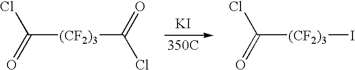
This product was then reacted with hydroxyethyl methacrylate in pyridine to create a monomer that was further modified with 4′-hydroxy-4-biphenylcarbonitrile. 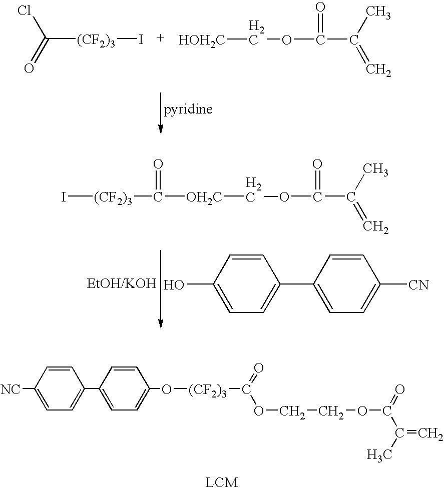
This monomer (LCM) was subsequently polymerized with other monomers to form a polymeric liquid crystalline product as described below.

10 wt% LCM with 30 wt-% trifluoroethyl methacrylate, 50 wt-% tetrafluoropropyl methacrylate, 5 wt-% hydroxyethyl methacrylate, and 5 wt-% silyl methacrylate monomers were polymerized in dioxane in accord with typical free radical polymerization processes (Soremon and Campbell, Preparing Methods of Polymer Chemistry, 1961, lnterscience Publishers, New York, N.Y., pp. 149-215). The resulting product had excellent optical quality, good phase dispersion of the liquid crystalline material and good EO properties. This system also did not degrade (migration of the liquid crystalline material or loss of optical quality) under thermal aging at 80° C. for 40 hours.

### EXAMPLE C

This example reports a new approach for enhancing the phase dispersion of liquid crystalline materials, either as a guest in a host polymer, or attached to a polymer (high or low refractive index) backbone. This new procedure modifies either a high or low refractive index polymer with a unique combination of liquid crystal (LC) compatibilizing structures that stabilize LC dispersions while maintaining optical clarity and good NLO properties at very low concentrations of LC materials. Table 5 shows some of the problems associated with prior art LC materials and polymers. Table 6 shows how the modification of polymers and LC materials of this invention results in total systems that have a good balance of optical clarity, stable phase dispersions, and good NLO properties at low concentrations of LC materials.

TABLE 5
Prior Art LC Systems - High LC Concentrations (>50%)

| | | | All-hydrocarbon | | |
|---|---|---|---|---|---|
| | | | LC material | | |
| | | | attached to an | | |
| | | | all-hydrocarbon | Fluorocarbon- | |
| | All-hydrocarbon | All-hydrocarbon | polymer | modified | |
| System | polymer | LC material | backbone | LC material | Results |
| 1 | Yes | Yes | — | — | Poor optical |
| | | | | | properties and poor |
| | | | | | dispersion stability |
| 2 | — | — | Yes | — | Poor optical |
| | | | | | properties but good |
| | | | | | dispersion stability |
| 3 | Yes | — | — | Yes | Poor optical |
| | | | | | properties and poor |
| | | | | | dispersion stability |

TABLE 6
LC Systems of This Invention - Low LC Concentrations (<30%)

| | Fluoropolymers | Hydrocarbon | | | |
|---|---|---|---|---|---|
| | modified with | polymers modified | | | |
| | fluorinated or non- | with fluorinated or | | | |
| | fluorinated LC | non-fluorinated LC | | | |
| | compatibilization or | compatibilization or | | | |
| | polar functional | polar functional | Hydrocarbon | Fluorocarbon | |
| System | groups | groups | LC | LC | Response |
| 1 | Yes | — | Yes | — | Good optical properties, |
| | | | | | good EO, good phase |
| | | | | | dispersion stability |
| 2 | Yes | — | — | Yes | Good optical properties, |
| | | | | | good EO, good phase |
| | | | | | dispersion stability |
| 3 | — | Yes | Yes | — | Good optical properties, |
| | | | | | good EO, good phase |
| | | | | | dispersion stability |
| 4 | — | Yes | — | Yes | Good optical properties, |
| | | | | | good EO, good phase |
| | | | | | dispersion stability |

The above-tabulated data is depicted graphically in FIG. 6 also

### EXAMPLE D

Additional examples of this invention are as follows:

TABLE 7
Prior Art LC materials

| System | Materials | Response |
|---|---|---|
| 1 | • All hydrocarbon polymer (pMMA) | • EO = 0.1-0.2 pm/V² |
| | • All hydrocarbon LC material (5OCB or | • 70% transmission |
| | 8OCB) at a 10 wt% loading in the polymer | at 380 nm, 0% |
| | (n > 1.5) | transmission at |
| | | 430-530 nm, 10% |
| | | transmission at |
| | | 580-680 nm |
| 2 | 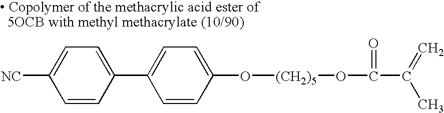 | • EO = 0.1-0.2 pm/V²• 70% transmission at 380 nm, 0% transmission at 430-530 nm, 10% transmission at 580-680 nm |

TABLE 8
LC Materials of this Invention*

| System | Materials | Response |
|---|---|---|
| 1 | Fluorocarbon terpolymer (Spike 3) | EO >6.0 pm/V² |
| | All hydrocarbon LC material | 26% transmission at |
| | (5OCB) at a 10 wt % loading in the | 380 nm, 0% |
| | polymer. | transmission at 420-540 |
| | | nm, 80% |
| | | transmission at 620-680 |
| | | nm |
| 2 | Fluorocarbon copolymer (Run 18) | EO = 0.1 pm/V² |
| | All hydrocarbon LC material | 97% to 98.5% |
| | (5OCB) at a 12.1 wt % loading in | transmission between |
| | the polymer. | 430-480 nm, 96.5% to |
| | | 98% transmission at |
| | | 480-580 nm, 96.5% |
| | | transmission at 580-690 |
| | | nm |
| 3 | Fluorocarbon homopolymer | EO = 0.15 pm/V² |
| | (pTFPMA) | |
| | 13.2 wt % fluorinated LC in | 25% to 40% linear light |
| | polymer. | transmission between |
| | | 380-690 nm |

*TFEMA = trifluoroethyl methacrylate monomer TFPMA = tetrafluoropropyl methacrylate monomer HEMA = hydroxyethyl methacrylate monomer

### EXAMPLE E

### Crosslinked LC-Polymer System

A fluoropolymer containing 50% TFEMA, 40% TFPMA, and 10% of an isocyanate functional methacrylate ester was prepared in a conventional solution (dioxane-20% solids) free radical polymerization method. To this solution was added 20% of another fluoropolymer that contained hydroxyl groups, VP02 (80% TFEMA/20% HEMA) and 15% of a liquid crystal (4′pentyl-biphenylcarbonitrile). This mixture (65 parts isocyanate functional polymer, 20 parts of the hydroxyl-containing fluoropolymers and 15 parts LC) in dioxane was applied to an electrooptic test cell, dried into a 10-20 μm thick film and tested for EO response. EO values of 12-16 pm/V² were observed.

Changing the hydroxyl functional polymer to VP03 (60% TFEMA, 20% MMA/20% HEMA) and then combining with the isocyanate functional polymer and LC compound resulted in EO values of 6-10 pm/V².

### EXAMPLE F

### UV Curable Reactive LC Fluoropolymer and Non-Fluoropolymer Systems

A combination of different curable monomers, LC materials and photosensitizers are shown in Table 8.

TABLE 9
Examples of LC Materials* of the Invention

| | | | | | | | | n_{D} of |
|---|---|---|---|---|---|---|---|---|
| Sys- | | | | | | | | solu- |
| tem | TMPTA | TMPBDA | TFEMA | NVP | THFMA | LC | PS | tion |
| 1 | 10 | 10 | 50 | 18 | 0 | 10 | 2 | 1.441 |
| 2 | 10 | 5 | 50 | 9 | 9 | 15 | 2 | 1.441 |
| 3 | 10 | 10 | 50 | 6 | 7 | 15 | 2 | |
| 4 | 10 | 5 | 50 | 13 | 10 | 10 | 2 | |
| 5 | 10 | 28 | 0 | 25 | 25 | 10 | 2 | 1.503 |

*TMPTA = trimethylolpropane triacrylate, n_{D} = 1.4740
TMPBDA = trimethylolpropane benzoate diacrylate, n_{D} = 1.5110
TFEMA = trifluoroethyl methacrylate, n_{D} = 1.3610
NVP = N-vinylpyrrolidone, n_{D} = 1.5120 (polar monomer)
TFHMA = tetrahydrofurfuryl methacrylate, n_{D} = 1.4580
LC = 5OCB or 8OCB, n_{D} ˜1.57
PS = diethoxyacetophenone, n_{D} = 1.4990
where, n_{D} is refractive index at 589 nm

Each of the five 100% reactive liquid systems were applied to EO test cells and irradiated with a 275 watt General Electric Company (GE) sunlamp for 40 minutes under an Ar inert atmosphere. All the systems had EO response values that ranged from 1-6 pm/V².

### EXAMPLE G

Polymer Host System

A porous sol-gel system was prepared by crosslinking of Si(OCH₃)₄ (hydrolysis reactions described in Sol-Gel Techniques for Thin Films, Fibers, Preforms, Electronics, and Specialty Shapes, Lisa C. Klein ed., Nukes Publications, Park Ridge, N.J., 1988). Novel modifications of these known sol-gel reactions were made using fluorinated silanes (1H, 1H, 2H, 2H-perfluorinated triethoxysilanes), either alone or in combination with nano-size silica particles to produce low or medium (n<1.5) refractive index gel structures.

The porous sol-gel structures were created between coplanar gold electrodes on a quartz slide with a gap of 20 μm between the electrodes. Conventional or fluorinated liquid crystalline compounds (in solvent) or polymer solutions of the liquid crystalline compounds were absorbed into the porous sol-gel structures, dried, and tested for their ability to respond in a nonlinear-optical behavior under influence of an electric field, using the testing procedure described previously. The NLO results from the sol-gel structures were similar to those polymer liquid crystalline samples that were not absorbed into a sol-gel structure.

### EXAMPLE H

### Polymer Host System

The liquid crystal materials of this invention also can be incorporated into hybrid (organic-inorganic) or nano-composite polyester polymers (these polymers are described by R. van der Linde and S. Frings, in the paper presented at the 6^{th} Biennial North American Research Conference on “The Science and Technology of Organic Coatings”, Nov. 5-8, 2000 at the Westin Resort Hotel, Hilton Head Island, S.C.—proceedings published by The Institute of Materials Science, New Paltz, N.Y.).

The liquid crystal materials of this invention also can be incorporated into highly branched or dendritic polymers that contain fluorine groups in their backbone structures. A description of how to prepare these branched/dendritic polymers can be found in Polymer Science, and International Review Journal, May 2000, vol. 25, K. Inoue, pp 453-571.

### (IV)—Applications of Novel Liquid Crystals and Liquid Crystal/Polymer Blends

### EXAMPLE I

### EO Cell with a PDLC Film (117-145-31)

A PDLC film was prepared by the SIPS method, using 20.9 mg of liquid crystal 5CB (4-pentyl-4′-biphenylcarbonitrile, purchased from Aldrich) with 55.7 mg of the styrene-co-MMA polymer (also purchased from Aldrich), jointly dissolved in dioxane. The liquid crystals composed 27.3% of the solids in the film. 5CB is the prototypical nematic liquid crystal, and is commonly used for demonstrations of new phenomena. An EO test cell was prepared and tested for response using the procedure described previously. The response of the system is shown in the following Table.

TABLE 10
EO Response as a Function of DC Bias Field

| DC bias (V/μm) | Temperature | EO Response (pm/V²) |
|---|---|---|
| 10 | 22° C. | 0.075 |
| 15 | 22° C. | 0.074 |
| 15 | 50° C. | 0.113 |

These results show that this invention is not obvious, as the prototypical liquid crystal system leads to an EO effect much smaller than that of other material combinations.

### EXAMPLE J

### EO Cell with a PDLC Film (133-46-33)

A PDLC film was prepared using the SIPS method, using an OPI low-index terpolymer (Run 46) and 5OCB (4-pentyloxy-4′-biphenylcarbonitrile, purchased from Aldrich) as the liquid crystal. The resulting film was composed of 11.6 wt-% liquid crystal. The material was prepared as described above. Several EO test cells were fabricated as described above. The cells were then tested to determine the response both as a function of temperature and DC bias voltage. The results are shown in the following tables.

TABLE 11
EO Response as a Function of DC Bias Field

| DC bias (V/μm) | EO Response (pm/V²) |
|---|---|
| 5 | 0.209 |
| 10 | 0.206 |
| 15 | 0.266 |
| 20 | 0.374 |
| 25 | 0.523 |
| 30 | 0.537 |
| 35 | 0.455 |

TABLE 12
EO Response as a Function of Film Temperature

| Temperature (° C.) | EO Response (pm/V²) |
|---|---|
| 25 | 0.120 |
| 29 | 0.122 |
| 33 | 0.124 |
| 37 | 0.139 |
| 41 | 0.172 |
| 45 | 0.240 |
| 50 | 0.419 |
| 55 | 0.756 |
| 60 | 0.893 |
| 65 | 0.163 |

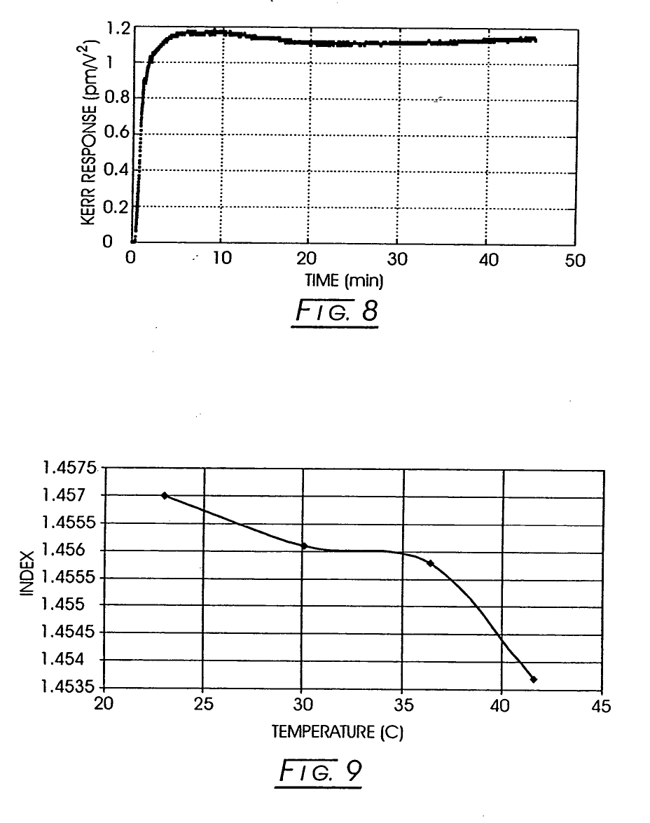

The response of this device also is shown in FIG. 7. Notice the appearance of a threshold voltage below , which there is no EO response, and also the saturation of the response as the droplets approach perfect alignment.

FIG. 7 shows the EO response as a function of temperature. The curve demonstrated the K/(T*−T) behavior expected from a nematic nearing the transition temperature. Note the rapid drop-off of the response as the temperature rises above the critical temperature.

These results show the EO response of the PDLC has strong temperature dependence and strong dependence of the bias field. Also, note there is an apparent maximum temperature for operation of the PDLC. Comparison of these results to those from the preceding example show the 5OCB has a response which, when scaled for wt-% of the liquid crystal, is more than 4 times larger than that of 5CB.

### EXAMPLE K

### Stability of an EO Cell with a PDLC Film (133-37-13)

A PDLC film was formed on an EO test cell, using the PIPS formation method. 2.4 mg of 5OCB was combined with 25.2 mg of polymer KP001 (containing 10% NCO groups for crosslinking) in dioxane, to create a solution that was approximately 5% solids. The solution was applied to an EO test cell and allowed to air dry at room temperature. The EO test cell was later heated to 60° C. at full vacuum in a vacuum oven (˜30 inches of Hg) for 30 minutes. The stability of the PDLC EO response was tested by measuring the EO overnight for more than 18 hours.

The EO response was stable within the errors introduced by the limited thermal control of the device. The previous example showed the strong dependence of the EO response on temperature. The drift in the response shown in this example is consistent with a change of less than 1° C. This example does show the PDLC have stable response over long time periods.

### EXAMPLE L

### EO Cell with a C-PDLC Film (133-85-9)

A C-PDLC film was prepared using the SIPS method. The solution composition was 6.6 mg of 5OCB, 5.2 mg OPI chromophore 119-96, and 56.37 mg of polymer KP001 (containing 10% NCO groups), jointly dissolved in dioxane. Drying at 70° C. led to a crosslinked polymer film, which was resistant to solvents. The material was used to produce EO test cells, which gave the following results.

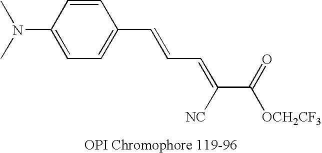

TABLE 13
EO Response as a Function of DC Bias Field at 37° C.

| DC bias (V/μm) | EO Response (pm/V²) |
|---|---|
| 10.000 | 1.5684 |
| 20.000 | 1.3724 |
| 30.000 | 1.2417 |
| 40.000 | 1.0620 |

TABLE 14
EO Response as a Function of Film
Temperature with 15 V/μm Bias Field

| Temperature (° C.) | EO Response(pm/V²) |
|---|---|
| 25.000 | 0.87136 |
| 29.000 | 0.98464 |
| 33.000 | 0.98682 |
| 37.000 | 1.0075 |
| 41.000 | 0.14595 |

Comparison of these results to those from Example J demonstrates the large enhancement of the EO response from including the chromophore. The enhancement also is much larger than would be measured for this chromophore distributed randomly in the polymer, as has been measured. At 37° C., the chromophore doped directly into the polymer would have no EO response, and even at higher temperature to optimize its response, the chromophore at this concentration would be expected to enhance the Kerr response by 0.1 pm/V² at most. Thus, this enhancement is not simply additive.

### EXAMPLE M

### EO Cell with a C-PDLC Film (133-95-9)

A C-PDLC film was prepared using the SIPS method. The solution composition was 9.2 mg of 5OCB, 5.3 mg OPI chromophore 119-96, and 79.2 mg of polymer Spike 3, jointly dissolved in dioxane. The material was used to produce EO test cells, which gave the following results.

TABLE 15
EO Response as A Function of DC Bias Field at 41° C.

| DC bias (V/μm) | EO Response (pm/V²) |
|---|---|
| 5.0000 | 1.3332 |
| 10.000 | 1.7645 |
| 15.000 | 1.8952 |
| 20.000 | 1.8135 |
| 25.000 | 1.5227 |
| 30.000 | 1.2853 |

TABLE 16
EO Response as a Function of Film Temperature with 15 V/μm Bias Field

| Temperature (° C.) | EO Response (pm/V²) |
|---|---|
| 25.000 | 0.44113 |
| 29.000 | 0.52608 |
| 33.000 | 0.70580 |
| 37.000 | 0.98028 |
| 41.000 | 1.5249 |

The EO response as a function of time is displayed in FIG. 8. These results show the existence of the large EO response and stability of the response, using a non-crosslinked polymer system. This is important because it is much easier to fabricate devices using a non-crosslinking polymer. Also, the response in Table 6 drops rapidly at temperatures above 41° C. At 46° C., there was no measurable response, and the transmission of the EO cell was greatly diminished.

### EXAMPLE N

### Performance of a Mach-Zehnder Device with PDLC Cladding (Shark1)

A Mach-Zehnder device was constructed as is shown in FIG. 3. The PDLC was initially formed using the SIPS method, with 5.9 mg of 5OCB dissolved in 39.5 mg of polymer Run46. After the solvent was removed, the film was heated to greater than 120° C. to enable attachment of the top electrode cover plate. During this process, the microstructure may have altered, due to a TIPS-like process. The device was tested to determine the voltage required to create a phase shift of π along one arm of the device. The electrodes were spaced 15 μm apart, and were several microns above the waveguides. The device was tested at 85° C., where sufficient light would propagate along the waveguides to enable the measurement. By varying the voltage applied to the system, it was determined that approximately 3000 V was required to cause a π phase change in the device. This large voltage is to be expected, in light of the results from FIG. 8, showing the small EO response at elevated temperatures for this material.

### EXAMPLE O

### Refractive Index Prism and EO Cell with a C-PDLC Film (133-95-22)

A C-PDLC film was prepared using the SIPS method. The solution composition was approximately 11.58% of 5OCB, 5.47% OPI chromophore 119-96, in polymer Spike 3, jointly dissolved in dioxane. The material was used to produce EO test cells and prisms for refractive index measurements, giving the following results.

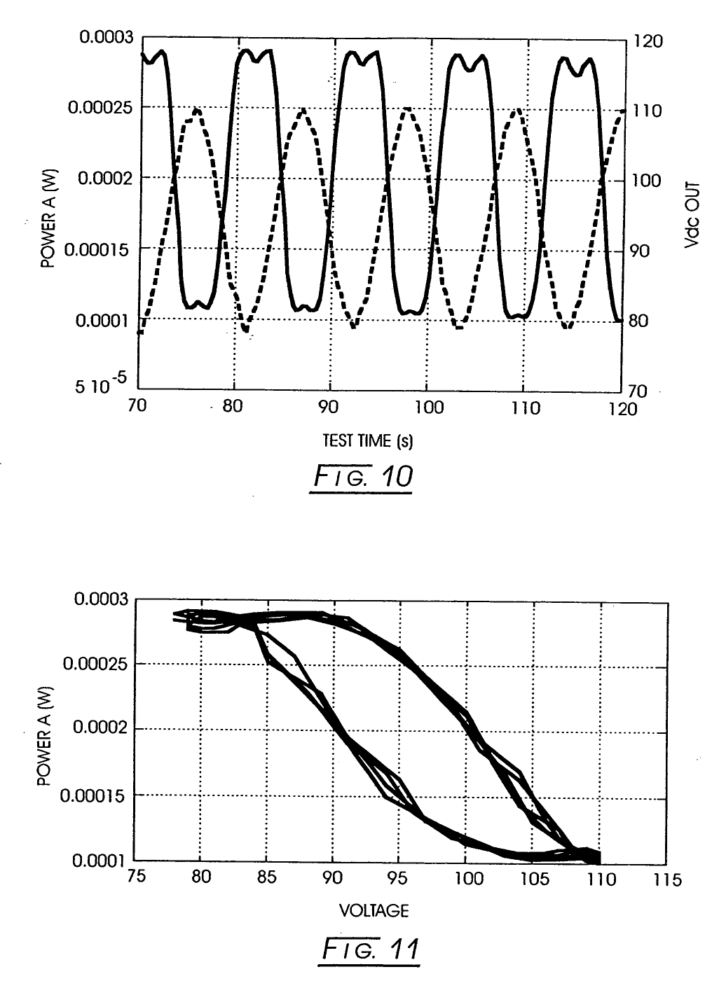

The solution was initially prepared with lower concentration of the liquid crystal and chromophore. An aliquot was removed, applied to a prism, and the dried in a 70° C. oven for approximately 1 hour. The refractive index of the LC-containing film was then measured using standard methods (H. Onodera, I. Awai, and J.-I. Ikenoue, “Refractive index measurement of bulk materials: prism coupling method”, Applied Optics, Vol. 22, 1194-1197, 1983). By measuring the refractive index at various temperatures, the curve displayed in FIG. 9 was prepared.

Because the refractive index at room temperature was higher than desired, additional polymer in dioxane was added to the solution. A second prism was prepared, and tested in the same manner, giving a refractive index of 1.4461 at room temperature. This final solution was then used to fabricate the EO cells used in the following tests.

EO testing was performed using a variable DC bias voltage and a 1 kHz, 200 V peak-to-peak, AC signal, and measuring the response of the system at 1 kHz using a lock-in amplifier. Examination of the EO response at the various temperatures shows the EO has a large drift over time at 40° C., while at 45° C. the response is much more stable. Similar behavior is evident in devices made with this material, as is shown in the next example.

TABLE 17
EO as a Function of Temperature for the C-PDLC Material

| Temperature (° C.) | EO Response (pm/V²) |
|---|---|
| 25 | 0.46 |
| 29 | 0.53 |
| 33 | 0.65 |
| 37 | 0.87 |
| 41 | 1.00 |

TABLE 18
EO as a Function of Applied Voltage for the C-PDLC Material at 41° C.

| DC Bias (V/μm) | EO Response (pm/V²) |
|---|---|
| 5 V/μ | 1.11 |
| 15 V/μ | 1.11 |
| 25 V/μ | 0.65 |

### EXAMPLE P

### Performance of a Mach-Zehnder Device with C-PDLC Cladding (Sea Bass 4)

A Mach-Zehnder device was constructed as is shown in FIG. 3, using the material from the previous example. The PDLC was initially formed using the SIPS method. After the solvent was removed, the film was heated to greater than 120° C. to enable attachment of the top cover plate. During this process, the microstructure may have altered, due to a TIPS-like process. The device was tested to determine the voltage required to create a phase shift of π along one arm of the device. The electrodes were spaced 15 μm apart, and were several microns above the waveguides.

The device was tested at 40° C., where sufficient light would propagate along the waveguides to enable the measurement. By varying the voltage applied to the system, it was determined that approximately 30 V with an 80 V bias was required to cause a π phase change in the device. The results from modulating the device with a sinusoidal signal are shown in FIG. 10. Note that the total power shows small ripples at both the maximum and minimum, indicating that the device has been slightly overdriven. The device is giving approximately 4 dB extinction, which can be primarily attributed to the power being unbalanced between the two arms of the Mach-Zehnder.

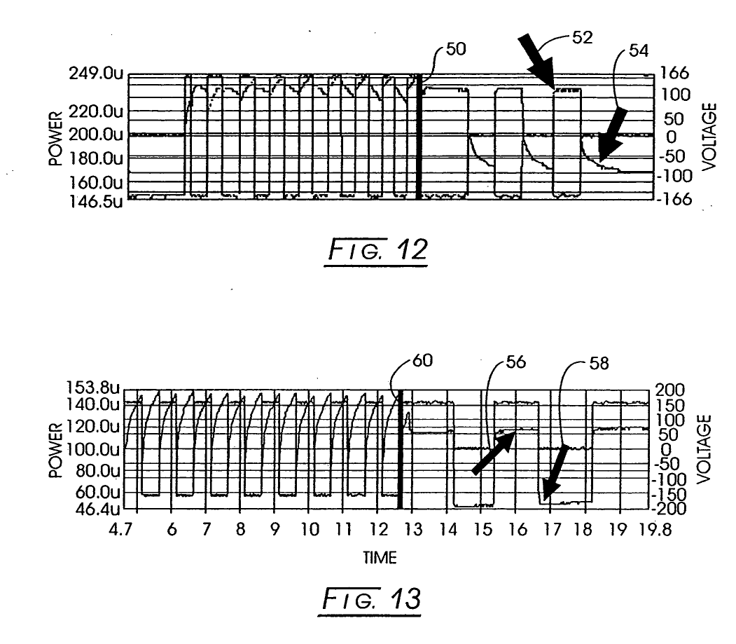

The repeatability of the response is shown in FIG. 11, which plots the output power as a function of the applied voltage. Here we see the formation of an ovoid shape, with little variation as the figure is re-traced by the repeated cycles. However, there is substantial hysteresis in the response, as evidenced by the two values of the power at a given voltage. In FIG. 11, the upper arm is associated with increasing voltage, and the lower arm with decreasing voltage.

### EXAMPLE Q

### Performance of a Mach-Zehnder Device with C-PDLC Cladding (Sea Bass 3)

A second Mach-Zehnder device was constructed, as in the previous example, and used for the testing in this example.

A common problem with PDLC films is charge buildup during pure DC operation. To eliminate effects due to possible device charging, testing was performed by applying an alternating square-wave waveform to the device. Because the director in liquid crystals depends solely on the magnitude of the electric field, not its direction, the alternating square-wave will allow for constant orientation of the director, while preventing charge buildup. There are three caveats to this statement. The first is that the frequency of the square-wave must be large enough that charge buildup does not occur during a half-cycle of the voltage, when a constant voltage is applied. Second, the time to cycle between the positive and negative voltages must be short compared to the orientation relaxation time of the liquid crystal, so no reorientation occurs during the voltage transition. Third, the inclusion of the chromophore in the Sea Bass material adds a component that responds to the direction of the applied field. As this example will demonstrate, this inclusion does not appear to complicate the response of the device nor to prevent simple analysis of the performance.

Initial testing of Sea Bass 3 with the alternating square-wave voltage was performed at 40° C. Based on the EO results, the maximum voltage applied to the device was 200 V. Shown in FIG. 12 is the power output from a Y-splitting Mach-Zehnder device, as a function of applied voltage. The alternating square-wave was initially driven at a frequency of 1 Hz (left of line 50), and then was driven at a frequency of 100 Hz (right of line 50) and turned on and off manually. Because of the sampling rate, the 100 Hz square wave appears to be a rippled constant voltage.

The performance of the device has been greatly enhanced by the use of the alternating square-wave. In particular, the response to voltage is much faster, and shows little drift (arrow 52). However, the device turn-off still shows a much longer response time than is desired (arrow 54).

The solution to the turn-off time problem came from closer examination of the EO cell results. As discussed previously, the Sea Bass material EO cell seemed to have its poorest response (large drift in EO) at 40° C., while at 50° C. the response was much more stable. The next series of tests on Sea Bass 3, thus, were performed at 50° C., with the results as shown in FIG. 13.

At 50° C., with the alternating square-wave applied, the device not only exhibited very stable response (arrow 56), but the turn-off time has also been greatly decreased (arrow 58). Again, the results to the left of the line 60 are for a square wave with frequency of 1 Hz, while those to the right of the line 60 are at 100 Hz, with the voltage manually switched on and off.

### EXAMPLE R

### Mach-Zehnder Device with PDLC Cladding (Fluorine 4)

A Mach-Zehnder device was constructed as is shown in FIG. 3, using a solution of 13.4% 5OCB and 11.6% HMDI in CP044 (153-087-22). The solution was coated only in the active region of the MZI chip. After the solvent was removed by vacuum drying at room temperature for 4.5 hours, the film was heated to 110° C. for 2 minutes then 145 C for 7 minutes to enable attachment of the top electrode cover plate and allow crosslinking of the polymer. The device was tested to determine the voltage required to create a phase shift of π along one arm of the device. The electrodes were spaced 15 μm apart, and were approximately 8 microns above the waveguides.

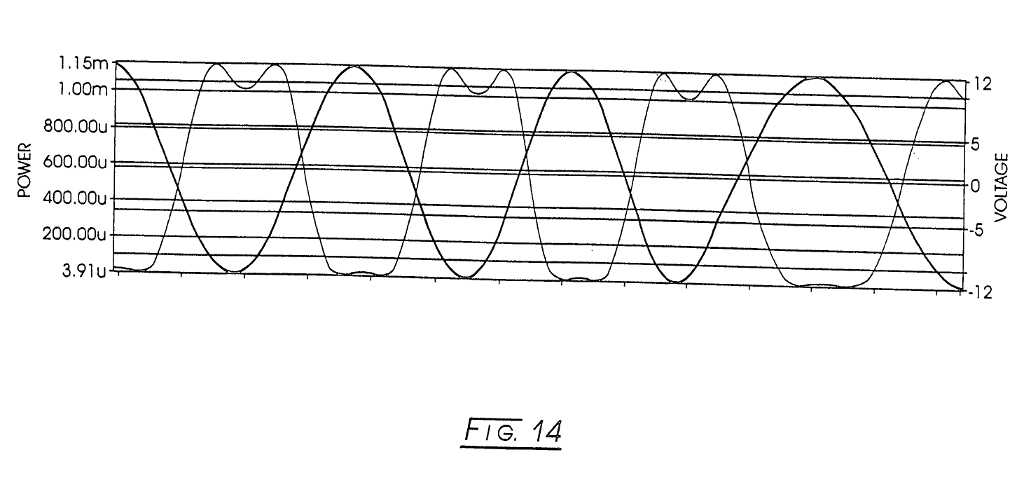

The device was tested at 45° C. (Test 16), where sufficient light would propagate along the waveguides to enable the measurement. By varying the voltage applied to the system, it was determined that approximately 17 V with a 26V DC bias was required to cause a π phase change in the device. The results from modulating the device with a sinusoidal signal are shown in FIG. 14. Note that the total power shows ripples at both the maximum and minimum voltage, indicating that the device has been slightly overdriven. The device gives more than 24 dB extinction. This level of extinction can only be achieved by having almost perfectly balanced loss along both arms of the MZI. This device verifies that the application of voltage to change the phase along one arm is not altering the optical loss along that arm. The fact that the MZI is able to be overdriven shows that the device is operating through phase change along one arm, not through a loss-based mechanism.

### EXAMPLE S

### High and Intermediate Refractive Index Systems

TABLE 20

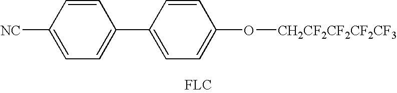

Fluorine-Containing LC Molecules

| System | Performance |
|---|---|
| 20% FLC in 100% hydrocarbon | High n, high EO (˜3pm/V²), |
| polymer (poly(bisphenol A) | good optical clarity |
| carbonate, purchased from | |
| Aldrich) | |
| 13% FLC in CP034 (pTFEMA) | Low n, low EO (˜0.2 pm/V²), |
| | very good optical clarity |
| 11% FLC in Run18 | Intermediate n, low EO (˜0.1 pm/V²), |
| (66% TFEMA/34%MMA) | very good optical clarity |
| 11.5% FLC in PMMA | Intermediate n, low EQ (˜0.2 pm/V²), |
| | good optical clarity |
| 11.5% FLC in VP01 | Intermediate n, EO (˜0.7 pm/V²), good |
| (80% MMA/20%HEMA) | optical clarity |

TABLE 21
UV-Curable Crosslinking Systems*

| | | | | | | | | EO | Optical | Mechanical |
|---|---|---|---|---|---|---|---|---|---|---|
| System | TFEMA | TFPMA | HEMA | TMPTA | PS | LC | RI | Response | Clarity | Properties |
| 1 | 30.5 | 0 | 30.5 | 30.5 | 2.4 | 6.1 | 1.4465 | | 10 | G |
| 2 | 45 | 0 | 22 | 22.5 | 1.5 | 9 | 1.4323 | | 10 | G |
| 3 | 17 | 47 | 12.5 | 9 | 3.5 | 10.7 | 1.4279 | 13 pm/V² | 5 | G |
| 4 | 17 | 37.3 | 12.7 | 18 | 3 | 12 | 1.4363 | 2 pm/V² | 9 | G |
| 5 | 50 | 0 | 13.4 | 17.4 | 7.7 | 11.5 | 1.4337 | 3 pm/V² | 8 | G |
| 6 | 20 | 0 | 0 | 30 | 3 | 50 | 1.5 | 7 pm/V² | 0 | NG |

*Ingredients
TFEMA = trifluoroethyl methacrylate
TFPMA = tetrafluoropropyl methacrylate
HEMA = hydroxyethyl methacrylate
TMPTA = trimethylolpropane triacrylate
PS = photosensitizer DAROCURE 1173
LC = liquid crystal 5OCB
RI = refractive index (589 nm)
EO = electrooptic coefficient at 1550 nm, 1 kHz
All % are by weight
Optical Rating
8-10 Clear (80-100% light transmission)
5-8 Hazy (50-80% light transmission)
3-5 Slightly cloudy but acceptable (30-50% light transmission)
0-3 Opaque (unacceptable)
Mechanical Properties Rating
G = good mechanical film properties (hard, good adhesion to glass substrates)
NG = not good mechanical film properties (soft, poor or no adhesion to glass substrate)

TABLE 22
Hydrocarbon LC Systems*

| Polymer | | Polymer RI | | EO Response | | Optical |
|---|---|---|---|---|---|---|
| Name | Polymer Composition | (1550 nm) | LC (%) | (1550 nm, 1 kHz) | | Quality |
| CP034 | 100% TFEMA | 1.4113 | 8OCB (11%) | 4 | pm/V² | 5-6 |
| CP033 | 100% TFPMA | 1.3942 | 8OCB (14%) | 13 | pm/V² | 3 |
| Run46 | 21% TFEMA, 52% TFPMA, 27% HEMA | 1.4336 | 8OCB (13%) | 7 | pm/V² | 7 |
| Run46 | 21% TFEMA, 52% TFPMA, 27% HEMA | 1.4336 | 5OCB (9.1%) | 8 | pm/V² | 6-7 |
| Spike 3 | 80.6% TFPMA, 14.4% TFEMA, 5% | 1.4189 | 5OCB (11.6%) | 5 | pm/V² | 7-8 |
| | HEMA | | | | | |
| pMMA | 100% PMMA | 1.47-1.48 | 5OCB (11.3%) | 0.2 | pm/V² | 9-10 |
| pMMA | 100% PMMA | 1.47-1.48 | 5OCB (50%) | 7 | pm/V² | 0-2 |
| pMMA | 100% PMMA | 1.47-1.48 | 5OCB (11.5) | 0.1 | pm/V² | 9-10 |
| CP056 | 65% TFEMA, 30% MMA, 5% HEMA | 1.4306 | 5OCB (11.5%) | 0.5 | pm/V² | 9 |
| Run18 | 66% TFEMA, 34% MMA | 1.4363 | 5OCB (12%) | 0.1 | pm/V² | 9-10 |
| CP052 | 25% HFIPA, 75% MMA | 1.4347 | 5OCB (12%) | 0.7 | pm/V² | 9 |
| CP051 | 50% TFEMA, 50% MMA | 1.4384 | 5OCB (12%) | 0 | pm/V² | 10 |
| CP044 | 20% TFEMA, 65% TFPMA, 15% HEMA | 1.4263 | 5OCB (11%) | 3.5 | pm/V² | 8 |
| VP01 | 80% MMA, 20% HEMA | 1.49 | 5OCB (11%) | 2 | pm/V² | 5-6 |
| KP001 | 10% NCO, 55% HFBMA, 35% TFEMA | 1.4129 | 5OCB (9.5%) | 13 | pm/V² | 5 |

*Ingredients
TFEMA = trifluoroethyl methacrylate monomer
TFPMA = tetrafluoropropyl methacrylate monomer
MMA = methyl methacrylate monomer
HEMA = hydroxyethyl methacrylate monomer
HFIPA = hexafluoroisopropyl acrylate monomer
HFBMA = hexafluorobutyl methacrylate monomer
NCO = isocyanate functional methacrylate monomer
RI = refractive index (589 nm)
All % are by weight
Optical Rating
8-10 Clear (80-100% light transmission)
5-9 Hazy (50-80% light transmission)
3-6 Slightly cloudy but acceptable (30-50% light transmission)
0-4 Opaque (0-30% light transmission)

### EXAMPLE T

### Optical Modulation by C-PDLC Materials

The chromophore-containing liquid crystal materials of this invention also can be used to provide high-speed modulation of optical signals. In conventional EO polymers, the chromophores are ordered by applying a large electric field while heating the chromophore/polymer composite to near or slightly above its glass transition temperature, and then cooling the material to lock in the alignment. To stabilize the EO performance, these devices commonly operate with a constant bias voltage of several to tens of volts per micron to prevent depoling over time.

C-PDLC materials can provide similar function. While conventional PDLC materials are capable of modulating light at low frequencies, they have minimal response at the frequencies of interest for optical modulation (100 MHz-40 GHz) because the rotation of the molecules does not occur rapidly enough, and the LC molecules typically possess small optical nonlinearities. By including a chromophore with large optical nonlinearity, it is possible to provide modulation at microwave frequencies. The chromophore used must incorporate itself into the LC domains, where it aligns with the director. Application of the low voltage needed to orient the director in the droplet will also serve to align the chromophores, providing the anisotropic orientation needed to observe the optical nonlinearity of the chromophore. By using a low refractive index C-PDLC material as the cladding over silica waveguides, it is possible to modulate the optical signal contained within the waveguides.

### EXAMPLE U

### Photonic Band Gap Composite Media

The liquid crystal materials of this invention can also be incorporated into photonic band gap composites. Photonic band gap composites consist of regularly arranged 3-dimensional arrays of particles or voids that prevent transmission of a specific wavelength(s) of light in specific directions. The wavelengths of the band gap are determined by the size and spacing of the array, and the refractive index mismatch between the two material comprising the array and the host matrix. One or both components of the composite comprise an electrooptical material. By altering the refractive index of the electrooptic material, it is possible to tune the photonic band gap or alter the forbidden propagation direction. We envision using the LC materials of this invention as either component of the photonic band gap composite.

### EXAMPLE V

### Crosslinked LC-Polymer System Using LC Blend (153-030-02)

CP044 with 11.02% of the commercial LC blend BL003 (purchased from Merck) in dioxane was applied to an electrooptic test cell, dried into a 10-20 μm thick film and tested for EO response. EO values of 8-60 pm/V were observed. Similar solutions were prepared using 10%-11.5% TL203 ((purchased from Merck) or M15 ((purchased from Merck), with resulting EO values ranging from 1.0 to 4.0 pm/V².

A 10.09% M15 in CP044 solution (153-030-20) was also applied to a MZI device and fabricated as described previously (Aegean Sea 2). The device was driven by a 300V sine wave, and exhibited a Vπ of approximately 300V.

### EXAMPLE W

### Crosslinked LC-Polymer System with Plasticizer

CP044 with 11.2% 5OCB and 16.93% dimethyl phthalate in dioxane (153-006-16) was applied to an electrooptic test cell, dried into a 15-30 μm thick film and tested for EO response. EO values of 1.0-3.0 pm/V² were observed. The EO response of the cell shut off at a lower temperature than was seen for equivalent solutions without the dimethyl phthalate. Similar solutions were prepared using 11.07% 5OCB with 1.20% methyl-1-naphthalene acetate, with resulting EO values ranging from 0.3 to 0.6 pm/V², with only a slight depression in the temperature where cell shut-off occurred.

### EXAMPLE X

### Crosslinked LC-Polymer System with Thermal Crosslinking

CP044 with 13.25% 5OCB and 5.96% HMDI in dioxane (153-093-25) was applied to an electrooptic test cell, dried into a 20 μm thick film, covered with a quartz slide, and heated to 170 C for approximately 5 minutes. This EO cell was then tested for EO response. EO values of 2.5-6.5 pm/V² were observed. The EO response of the cell shut off at a lower temperature than was seen for equivalent solutions without the HMDI. Similar solutions were prepared using up to 12% HMDI, or using isopherone diisocynate or N3600 (aliphatic polyisocyanate, purchased from Bayer) as the crosslinking agent. N3600 was used at lower concentration due to its higher functionality. Similar results were obtained using either of these alternate crosslinkers.

### EXAMPLE Y

### Crosslinked LC-Polymer System with Thermal Crosslinking Polymer

CP044 with 13.48% 5OCB was mixed with 20.70% of a polymer which included an isocyanate side group (153-116-33). The material in dioxane was applied to an electrooptic test cell, dried into a 20 μm thick film, covered with a quartz slide, and heated to 170 C for approximately 5 minutes. This EO cell was then tested for EO response. Large EO values of 2.5-6.5 pm/V² were observed.

### EXAMPLE Z

### PDLC Devices on other Substrates

The liquid crystal materials of this invention can also be incorporated onto alternate optical substrates. The examples given previously utilized the PDLC materials as the functional cladding on MZI devices fabricated from silica. The materials of this invention can be utilized equally well as the functional cladding of optical devices made with other materials, such as sol-gel glasses, SiON, or polymers as examples. The primary constraints are those stated previously, that the refractive index of the PDLC clad must be lower than that of the waveguide, and that the PDLC must have droplets small enough to allow good optical transmission while maintaining sufficiently large EO performance to allow for device operation.

### (V)—Additional Comments

While the invention has been described with reference to a preferred embodiment, those skilled in the art will understand that various changes may be made and equivalents may be substituted for elements thereof without departing from the scope of the invention. In particular, these materials are not limited to polymer-clad devices, but may be used more generally in devices where the core and/or cladding are active. Although liquid crystals have a long history of being used to control light transmission, we believe this is the first example where the liquid crystals are used to control the phase in the cladding of a waveguide. The liquid crystal/polymer material described above is just one method to create an inhomogeneous medium, which contains liquid crystalline domains. Other possible methods include application of a porous cladding to the waveguide and backfilling with liquid crystal, and embedding liquid crystal material between two rough polymer layers. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

We claim:

1. A functional optical material, which comprises:
(a) a liquid crystal (LC) evidencing a pair of refractive indices (RI's); and
(b) a polymer in which the LC is dispersed.

2. The functional optical material of claim 1, wherein the refractive index (RI) of said polymer is outside of the LC RI's by at least about 0.03.

3. The functional optical material of claim 2, wherein said LC RI's are about 1.7 and 1.5.

4. The functional optical material of claim 1, which additionally comprises a chromophore.

5. The functional optical material of claim 1, clad to an optical waveguide.

6. A functional optical material, which comprises:
(a) a liquid crystal (LC); and
(b) a polymer in which the LC is dispersed,
wherein said LC is less than about 5% miscible in said polymer.

7. The functional optical material of claim 6, wherein said LC evidences a pair of refractive indices (RI's) and the refractive index (RI) of said polymer is outside of the LC RI's by at least about 0.03.

8. The functional optical material of claim 6, clad to an optical waveguide.

9. The functional optical material of claim 6, which additionally comprises a chromophore.

10. The functional optical material of claim 7, wherein said LC RI's are about 1.7 and 1.5.

11. The functional optical material of claim 7, which additionally comprises:
(c) a plasticizer,
wherein the proportion of said plasticizer in said functional optical material controls the electrical output thereof.

12. A functional optical material, which comprises:
(a) less than about 20 wt-% liquid crystal (LC); and
(b) a polymer in which the LC is dispersed.

13. The functional optical material of claim 12, clad to an optical waveguide.

14. The functional optical material of claim 12, wherein said LC evidences a pair of refractive indices (RI's) and the refractive index (RI) of said polymer is outside of the LC RI's by at least about 0.03.

15. The functional optical material of claim 14, wherein said LC is less than about 5% miscible in said polymer.

16. The functional optical material of claim 12, which additionally comprises a chromophore.

17. The functional optical material of claim 14, wherein said LC RI's are about 1.7 and 1.5.

18. A functional optical waveguide, which comprises:
(a) a polymer having a refractive index, RI_{P}; and
(b) an optical waveguide clad having a refractive index, RI_{WG},
wherein RI_{P} is at least about 0.3% lower than RI_{WG} under operating conditions of said clad optical waveguide.

19. The functional optical material of claim 18, wherein said LC evidences a pair of refractive indices (RI's) and the refractive index (RI) of said polymer is outside of the LC RI's by at least about 0.03.

20. The functional optical material of claim 19, wherein said LC is less than about 5% miscible in said polymer.

21. The functional optical material of claim 20, which contains not more than about 20 wt-% LC.

22. The functional optical material of claim 19, which additionally comprises a chromophore.

23. The functional optical material of claim 19, wherein said LC RI's are about 1.7 and 1.5.

24. A functional optical material, which comprises:
(a) a liquid crystal (LC); and
(b) a polymer in which the LC is dispersed.
wherein said functional optical material has refractive index of less than 1.46.

25. The functional optical material of claim 24, wherein said LC evidences a pair of refractive indices (RI's) and the refractive index (RI) of said polymer is outside of the LC RI's by at least about 0.03.

26. The functional optical material of claim 25, wherein said LC is less than about 5% miscible in said polymer.

27. The functional optical material of claim 26, wherein the functional optical material contains not more than about 20 wt-% LC.

28. The functional optical material of claim 24, which additionally comprises a chromophore.

29. The functional optical material of claim 24, wherein said LC RI's are about 1.7 and 1.5.

30. A functional optical material, which comprises:
(a) a liquid crystal (LC); and
(b) a polymer in which the LC is dispersed, said polymer formed from the reaction product of one or more of:
(1) at least two pre-polymers having a weight average molecular weight of at least about 1,000; or
(2) a polymer having self cross-linking functional groups and reactive agent reactive with said self cross-linking functional groups.

31. The functional optical material of claim 30, which has refractive index of less than 1.46.

32. The functional optical material of claim 30, wherein said LC evidences a pair of refractive indices (RI's) and the refractive index (RI) of said polymer is outside of the LC RI's by at least about 0.03.

33. The functional optical material of claim 32, wherein said LC is less than about 5% miscible in said polymer.

34. The functional optical material of claim 33, wherein the functional optical material contains not more than about 20 wt-% LC.

35. The functional optical material of claim 30, which additionally comprises a chromophore.

36. The functional optical material of claim 30, wherein said LC RI's are about 1.7 and 1.5.

37. An optical device one or more of fabricated using or clad with a functional optical material, which comprises:
(a) a liquid crystal (LC); and
(b) a polymer in which the LC is dispersed, wherein the refractive index (RI) of said polymer is outside of the LC RI's by at least about 0.03;
said optical device capable of changing the phase of an optical signal without appreciable change in optical scattering of said optical signal.

38. The optical device of claim 37, wherein optical scattering is changed less than about 2 db/cm.

39. The optical device of claim 38, wherein optical scattering is changed less than about 0.5 db/cm.

40. The optical device of claim 37, which has refractive index of less than 1.46.

41. The optical device of claim 37, wherein said LC evidences a pair of refractive indices (RI's).

42. The optical device of claim 38, wherein said LC RI's are about 1.7 and 1.5.

43. The optical device of claim 39, wherein the functional optical material contains not more than about 20 wt-% LC.

44. The optical device material of claim 37, which additionally comprises a chromophore.

45. The optical device of claim 38, wherein said LC is less than about 5% miscible in said polymer.

46. A photonic band gap composite media formed from a host matrix and an array dispersed in said host matrix, wherein one or more of said host matrix or said array comprises:
(a) a liquid crystal (LC) having a refractive index (RI); and
(b) a polymer in which the LC is dispersed, wherein the refractive index (RI) of said polymer is outside of the LC RI by at least about 0.03.

47. The photonic band gap composite media of claim 46, which has refractive index of less than 1.46.

48. The photonic band gap composite media of claim 46, wherein said LC evidences a pair of refractive indices (RI's).

49. The photonic band gap composite media of claim 48, wherein said LC RI's are about 1.7 and 1.5.

50. The photonic band gap composite media of claim 46, wherein the functional optical material contains not more than about 20 wt-% LC.

51. The photonic band gap composite media material of claim 46, which additionally comprises a chromophore.

52. The photonic band gap composite media of claim 46, wherein said LC is less than about 5% miscible in said polymer.

53. A method for controlling the electrooptical output of functional optical material formed from a liquid crystal (LC) and a polymer in which the LC is dispersed, wherein said LC is less than about 5% miscible in said polymer, which comprises the step of:
adding a plasticizer to said functional optical material, the proportion of plasticizer in said functional optical material controlling the electrical output thereof.

54. The method of claim 53, wherein said functional optical material has refractive index of less than 1.46.

55. The method of claim 53, wherein said LC evidences a pair of refractive indices (RI's).

56. The method of claim 54, wherein said LC RI's are about 1.7 and 1.5.

57. The method of claim 56, wherein the functional optical material contains not more than about 20 wt-% LC.

58. The method material of claim 53, wherein said functional optical material additionally comprises a chromophore.

59. The method of claim 54, wherein said LC is less than about 5% miscible in said polymer.

60. A functional optical material, which comprises:
(a) a liquid crystal (LC); and
(b) a polymer in which the LC is dispersed,
wherein one or more of said LC or said polymer containing fluorine groups and said polymer contains at least 5 molar-% polar groups.

61. The functional optical material of claim 60, wherein said liquid crystal (LC) evidences a pair of refractive indices (RI's).

62. The functional optical material of claim 60, wherein the refractive index (RI) of said polymer is outside of the LC RI by at least about 0.03.

63. The functional optical material of claim 61, wherein the refractive index (RI) of said polymer is outside of the LC RI's by at least about 0.03.

64. The functional optical material of claim 61, wherein said LC RI's are about 1.7 and 1.5.

65. The functional optical material of claim 60, which additionally comprises a chromophore.

66. The functional optical material of claim 60, wherein said polymer is one or more of a thermoplastic polymer, a thermoset polymer, a sol gel, or a porous hybrid polymer.
